(19) United States
(12) Patent Application Publication
(10) Pub. No.: US 2015/0218499 A1
(43) Pub. Date: Aug. 6, 2015

(54) LEGLESS INSULATED FERMENTING TANK

(71) Applicant: Metalcraft Fabrication, Inc., Portland, OR (US)

(72) Inventors: Charles Frye, Portland, OR (US); Tom Sage, Portland, OR (US)

(21) Appl. No.: 14/476,531

(22) Filed: Sep. 3, 2014

Related U.S. Application Data
(60) Provisional application No. 61/934,079, filed on Jan. 31, 2014.

(51) Int. Cl. C12C 11/00

(52) U.S. Cl. CPC C12C 11/006

(57) ABSTRACT

The apparatus includes a fermentation tank of a type including a cylindrical tank shell and a downwardly-directed frustoconical tank bottom affixed to a bottom edge of the cylindrical tank shell. An upwardly-directed frustoconical support positioned below the cylindrical tank is configured to have a centrally located aperture for receiving and supporting a lower portion of the tank bottom. The tank includes an outer cylindrical sleeve configured to receive the cylindrical tank shell, tank bottom, and support to form a tank assembly, wherein the assembly includes an annular gap between the tank shell and sleeve, and a cavity between the sleeve, tank bottom, and support. Rigid foam insulation is then filled within the annular gap and cavity to provide structural rigidity to the assembly as well as insulative properties to maintain the stored liquid at a desired temperature.

### BACKGROUND OF THE INVENTION

This invention relates generally to tanks for use in fermentation processes and more particularly to insulated tanks for such purposes that include simplified manufacturing and enhanced rigidity.

Fermentation is the process by which yeast converts the sugars in the wort to ethyl alcohol and carbon dioxide gas—giving the beer both its alcohol content and its carbonation. To begin the fermentation process, the cooled wort is transferred into a fermentation vessel along with yeast. If the beer being made is an ale, the wort will be maintained at a constant temperature of 68° F. (20 C) for about two weeks. If the beer is a lager, the temperature will be maintained at 48° F. (9° C.) for about six weeks. Since fermentation produces a substantial amount of heat, the tanks must be cooled constantly to maintain the proper temperature. At the end of the fermentation cycle, the fermenter must cool the beer even further to preserve the yeast and clarify the beer.

Fermentation happens in tanks which come in all sorts of forms, from enormous cylindro-conical vessels, through open stone vessels, to wooden vats. Fermenters may also require insulation to help with temperature control. Outside tanks are insulated against ambient conditions, while indoor tanks will require insulation to lessen the demands on the temperature control system.

Most breweries today use stainless steel cylindro-conical vessels, or CCVs, which have a conical bottom and a cylindrical top. The cone's aperture is typically around 60°-70°, an angle that will allow the yeast to flow towards the cone's apex, but is not so steep as to take up too much vertical space. CCVs can handle both fermenting and conditioning in the same tank. At the end of fermentation, the yeast and other solids which have fallen to the cone's apex can be simply flushed out of a port at the apex.

A primary disadvantage to such CCVs is the cost and skilled manual labor that is required to manufacture them. Conventional designs require highly skilled labor to manufacture the many exacting pieces that must be fitted together to assemble the completed tank, and the tank designs typically require higher gauge steel to maintain structural rigidity. This drawback is especially true in designs where the tank is supported above the floor using four stainless steel legs that attach to the lower portion of the cylindrical tank. Furthermore, legged tanks suffer an additional disadvantage in that the weight of the tank must be spread out well over the connection points of the leg to the tank otherwise the tank walls are dimpled inward. Reinforcing support is often required in these areas as the legs and their connection points form the most likely point of failure for tank collapse, which vastly increases the number of weld points and increases manufacturing costs and complexity.

A need arises, therefore, for alternate designs that both simplify the design while maintaining structural rigidity.

### SUMMARY OF THE INVENTION

The invention generally involves a fermentation tank of a type having a cylindrical tank shell and a downwardly-directed frustoconical tank bottom affixed to a bottom edge of the cylindrical tank shell. An upwardly-directed frustoconical support positioned below the cylindrical tank is configured to have a centrally located aperture for receiving and supporting a lower portion of the tank bottom. The tank includes an outer cylindrical sleeve configured to receive the cylindrical tank shell, tank bottom, and support to form a tank assembly, wherein the assembly includes an annular gap between the tank shell and sleeve, and a cavity between the sleeve, tank bottom, and support. Rigid foam insulation is then filled within the annular gap and cavity to provide structural rigidity to the assembly as well as insulative properties to maintain the stored liquid at a desired temperature.

Also described is a method for constructing a fermentation tank of a type having a cylindro-conical container. The inventive method comprises supporting the cylindro-conical container in an upright orientation on an upwardly-directed frustoconical support to form an assembly. A cylindrical sleeve is then slid over the assembly so that an annular gap exists between the sleeve and assembly, and the annular gap filled with a rigid foam such as polyurethane.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is perspective view of a fermentation tank constructed according to teachings of the invention.

FIG. 2 is an exploded perspective view of the fermentation tank of FIG. 1 illustrating the assembly of the invention according to a preferred embodiment of the invention.

FIG. 3 is a side elevation view of the fermentation tank of FIG. 1 with internal features shown in dashed lines.

FIG. 4 is a section side elevation of the fermentation tank of FIG. 1.

FIG. 5 is a top plan view of the fermentation tank of FIG. 1.

FIG. 6 is a partially exploded perspective view of the foot assembly portion of the fermentation tank of FIG. 1.

FIG. 7 is a perspective view of a fermentation tank constructed according to an alternate embodiment of the invention.

### DETAILED DESCRIPTION

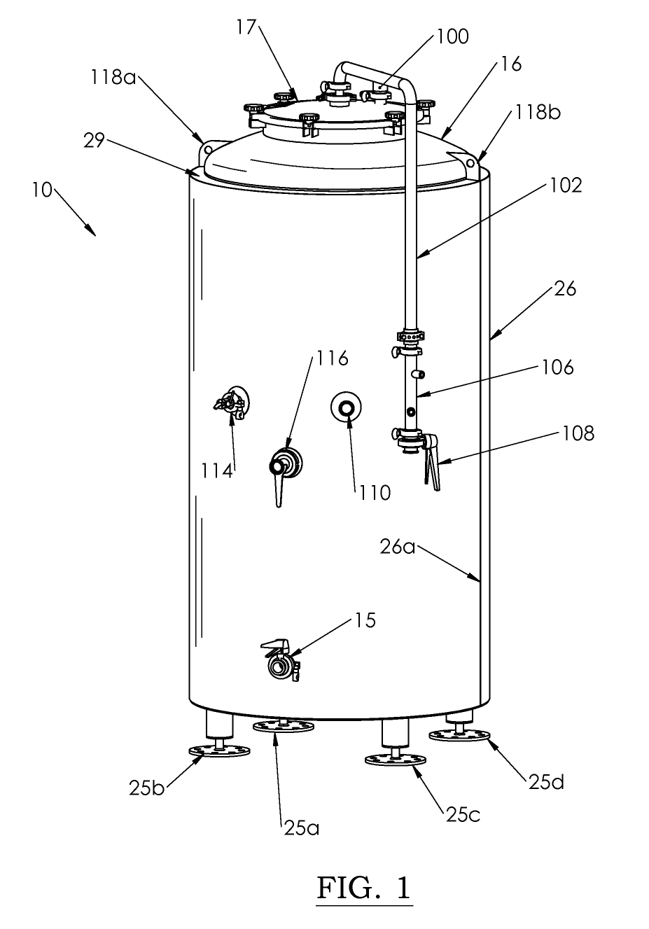

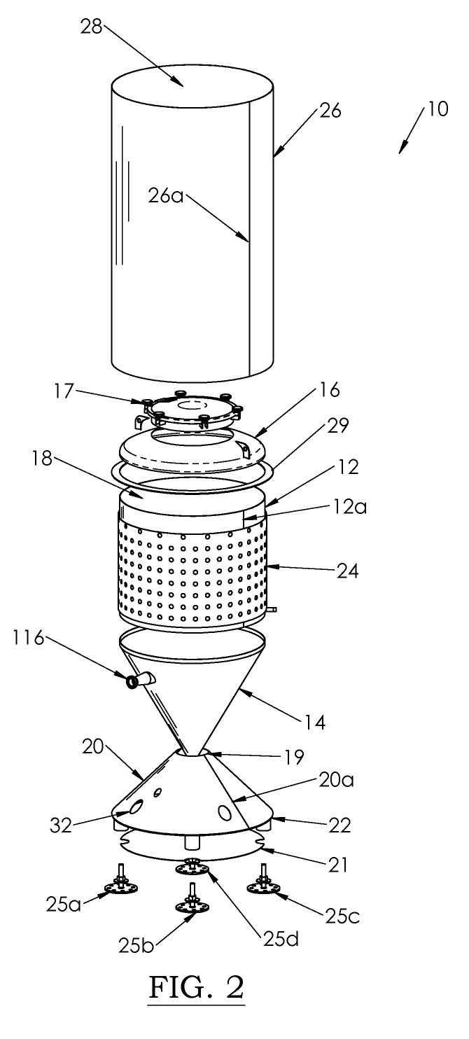

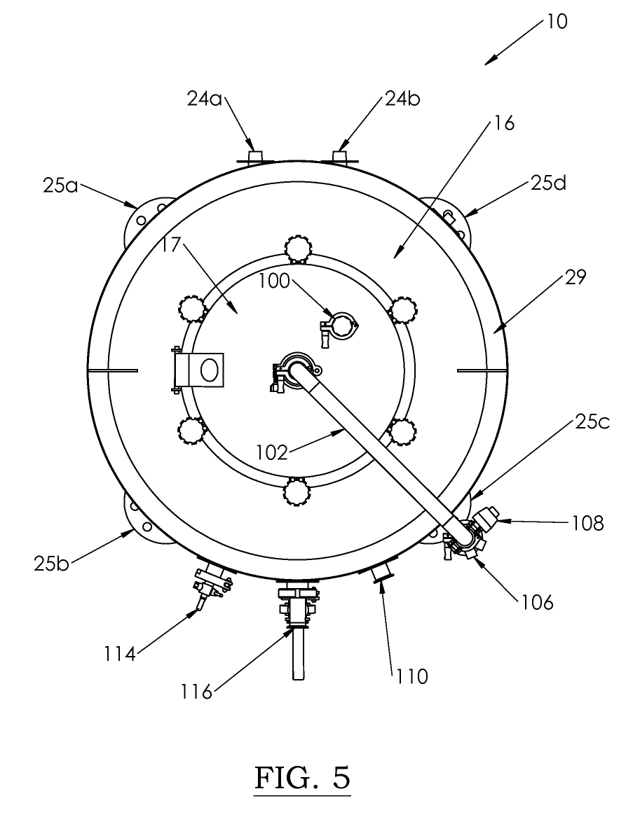

FIGS. 1-6 illustrate a fermentation tank assembly 10 as constructed according to teachings of the present invention. Assembly 10 includes a tank subassembly with a cylindrical tank shell 12 and downwardly-directed frustoconical tank bottom 14 affixed to a bottom peripheral edge of the cylindrical tank shell 12. The cone 14 that forms the lower portion of the tank is made by forcing a spinning flat disc against a form, similar to throwing a ceramic pot on a wheel. Alternately, the cone may also be made by hydroforming or by rolling and welding a flat pattern. All welds will be continuous. Interior wetted welds are ground smooth so they are sanitary. The cone forming tank bottom 14 has a preferred angle A of 60° whereby the yeast and other solids which have fallen to the cone's apex can be simply flushed out of a drain port 15 at the apex. The tank subassembly is capped on a top end by a tank head 16 to form a stainless steel cylindro-conical vessel (CCV) having a sealed and pressurized interior chamber 18 in which the beer is stored and fermented. A manway 17 is affixed over the top of head 16 to allow the addition of hops and other flavoring ingredients and to allow access to the tank for cleaning. A cooling jacket 24 is then wrapped about the cylindrical tank shell 12 and infused with a coolant such as compressed glycol—circulated through jacket ports 24a and 24b—to help maintain the fluid within the fermentation tank at a desired temperature.

In conventionally constructed fermentation vessels the manway 17 is situated low in the tank shell 12, i.e. midway up the tank wall sidewalls, which means it must breach two vessel walls. This is a very difficult construction step and creates an awkward position for cleaning the top portion of the inside of the vessel as debris, or material sloughing off the inside walls of the tank, is more likely to fall on the person attempting to do the cleaning. In embodiments of the invention these difficulties are solved by positioning the manway at the top of the cylindrical portion of the tank, above the liquid level and only insulating the tank up to the level of the bottom of the manway and liquid level. This serves the dual function of easing construction, since the manway only needs to breach a single wall of the tank, and of greatly enhancing the usefulness of the manway since the manway may now be used for easier cleaning, yeast harvesting and addition of various ingredients.

The fermentation tank assembly 10 includes a plurality of valves, ports, tubes, and other structures useful for the fermentation process and movement and maintenance of the tank assembly. As fermentation creates heat and pressure, a pressure and vacuum relief port 100 is coupled to manway 17. A clean-in-place (CIP) downtube 102 is coupled to a central portion of manway 17 and extends into the upper interior of the tank chamber 18, terminating in a rotating spray ball 104 for cleaning out the tank. Downtube 102 is coupled outside of the tank assembly 10 to a gas and pressure port 106 and to a butterfly valve 108. Gas or fluid, is provided through ports 106 or 108 to spray ball 104 which then sprays and cleans the interior 18 of the tank after each use. The cleaning fluid can then be exhausted from the chamber 18 out of the same drain port 15 as the solids and yeasts. Other ports into the interior of the tank are provided, including a carbonation port 110, a temperature well 112 through which a thermocouple is inserted to measure the temperature within the tank, and a sample port 114 through which the liquid stored and fermenting within the tank may be drawn and sampled. At least one racking arm, such as arm 116, is coupled to the tank to allow sampling of product from various levels within the tank by rotation of an angled tube. Lifting means are included such as lifting ears 118a, 118b formed on opposite sides of the tank head 16.

Whereas a conventional tank assembly would be supported using four legs in a framework that exposes the tank bottom 14 for draining, the present invention uses a different support apparatus. In the present invention, an upwardly-directed frustoconical support 20 is positioned below the cylindrical tank shell 12 and includes a centrally located aperture 19 that receives a lower portion of the tank bottom 14. A bottom cover 21 is affixed to an underside of support 20 and includes penetrations along its periphery so that feet assemblies can be attached to the lower peripheral ring 23 of the support 20 as described below. The bottom cover 21 provides a more easily cleaned surface on the bottom of the tank assembly 10. The lower peripheral edges 22 of support 20 preferably flair out to a diameter larger than that of the cylindrical tank shell for reasons that will be clear in the description below. The frustoconical support 20 preferably forms an angle B that is less than angle A of the tank bottom 14, and more preferably between 30° and 45°, with the preferred embodiment of the support cone having an angle of 45° between the support cone base and side walls.

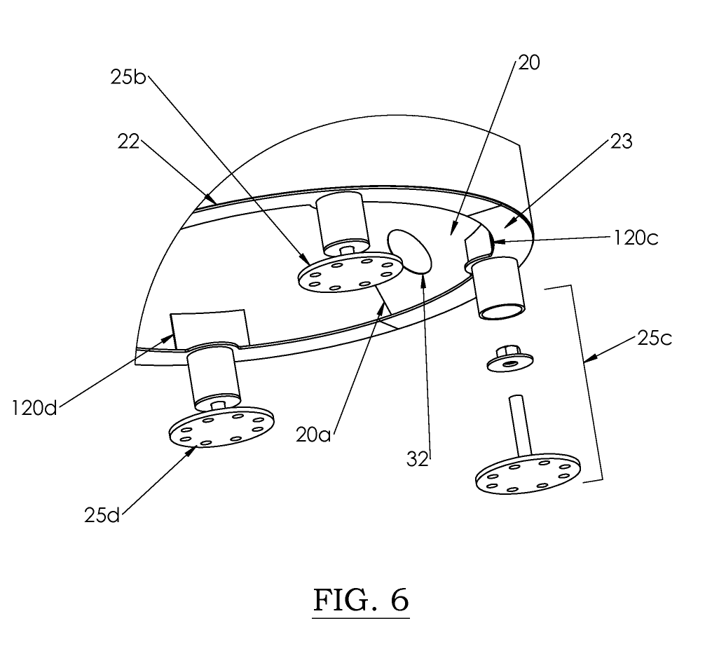

A plurality of foot assemblies 25a-25d are attached in spaced apart orientation to the lower peripheral ring 23 inwardly affixed to the lower peripheral edges 22 of frustoconical support 20, which are then additionally supported against the inner wall of support cone 20 by curved support members 120a-120d (FIG. 6). A nut and threaded stud within foot assemblies 25a-25d allows for height adjustability of individual feet.

Although a frustoconical shape for support 20 is preferred, other supports that do not depart from the spirit of the invention are contemplated, such as a dome shape, ribs that fan out radially from aperture 19, and a combination thereof. The base idea is that the initial support of the tank assembly via the inverted conical tank bottom is at the apex of the cone where the structure might be strongest, and that support at that apex is again at the apex of a support means such as cone, dome, or rib structure. Additional support of the tank assembly is provided by incorporating a rigid foam between inner and outer structures to bind them together and form a mono-body as described further below. The support cone 20 or dome is formed by laser cutting flat sheets, rolling two parts to form half cones and finally welding them together. Other methods are contemplated that will form the cone by pressing a flat shape into a sort of mold.

An outer cylindrical sleeve 26 is configured to receive the cylindrical tank shell 12, tank bottom 14, and support 20 to form the tank assembly 10, wherein the assembly includes an annular gap 28 between the tank shell 12 and outer sleeve 26, and a cavity 30 between the outer sleeve 26, tank bottom 14, and support 20. The cooling jacket 24 is installed around the cylindrical tank shell 12 within the annular gap 28. A support ring 29 bounds and seals a top of the annular gap 28 and is welded onto the outer sleeve 26 and head 16 which the lower cavity is sealed in part by the extent of the support 20 lower peripheral edges 22 and lower peripheral ring 23 welded to the outer sleeve 26 of assembly 10 having the same diameter as the outside of support ring 29.

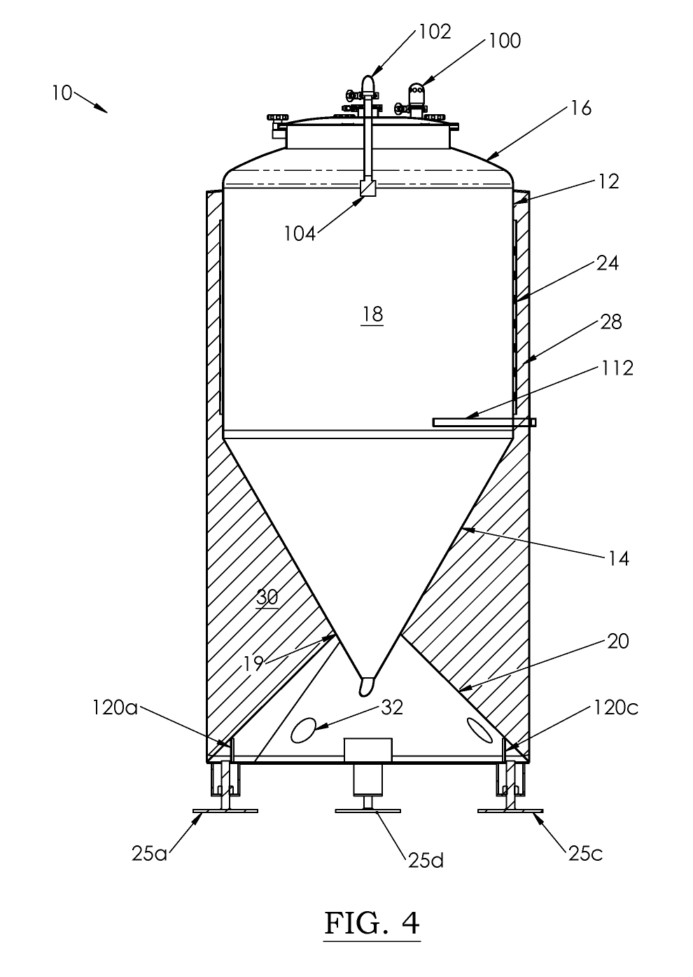

As best seen in FIG. 4, the annular gap 28 and cavity 30 are filled with a rigid foam insulation such as polyurethane to provide insulation and rigidity to the assembly 10 and to couple the elements together. Support 20 includes at least one foam fill ports formed therethrough, such as aperture 32, in fluid communication with the cavity 30 and with the annular gap 28, wherein the aperture is configured to receive the rigid foam insulation therethrough so that the tank assembly 10 can be inverted and foam flowed into and fill the cavity and annular gap. In this way, all stainless steel elements can be welded as needed and assembled together prior to installation of the foam so that all gaps between the outer shell 26 and inner tank subassembly are filled and the insulative properties of the completed assembly maximized.

The resulting structure has many advantages over conventional designs. First, the thermal insulation properties of the tank will be greatly improved over the industry standard because the foam insulation will fill all the gaps. Furthermore, the combination of inner and outer cylinders with the support cone and foam insulation will form a mono-body construction that will be considerably stronger than other forms of fabricating tanks.

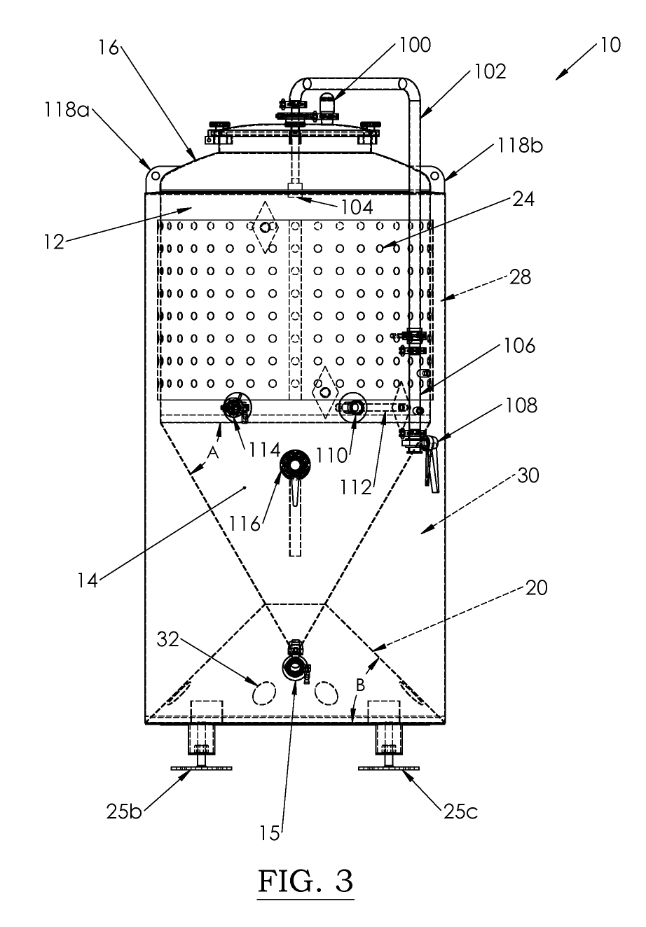

In the method for constructing a fermentation tank of a type having a cylindro-conical container, the method comprises supporting the container—formed at least of a cylindrical tank 12 and downwardly-directed frustoconical tank bottom—in an upright orientation on an upwardly-directed frustoconical support 20 to form a tank subassembly as illustrated in FIG. 3. A cylindrical sleeve 26 is then slid over the subassembly so that an annular gap—e.g. annular gap 28 and cavity 30—exists between the sleeve and subassembly. The tank assembly is then inverted and the annular gap filled with a rigid foam such as polyurethane to bind the assembly 10 together, impart structural rigidity to the assembly 10, and present an efficient insulating barrier between the inner and outer sections of the assembly where the foam conforms to the interior features of the tank and avoids the gaps in insulation that are normally required to allow for final welding operations.

Although it is preferred to fill the entire space 30 with urethane foam, cost considerations may require that only a portion of the space 30 be filled with foam in sufficient amounts to enhance the structural integrity of the resulting tank 10, or that the structure has sufficient structural rigidity so that it can be constructed without any rigid foam within space 30. Furthermore, an alternate embodiment for foaming the tanks involves spraying foam on the main tank 12 and then sliding the outer sleeve 26 over the resulting foamed structure, which may help for manufacture of larger tanks that are more difficult to invert and then fill through holes.

In one aspect of the inventive method, the step of filling the annular gap 28 and cavity 30 with rigid foam includes injecting foam through apertures 32 formed through the frustoconical support 20 where the apertures provide fluid communication between an underside of the support 20 and the cavity 30 and annular gap 28. In a further aspect of the invention, a cooling jacket 24 is installed about a cylindrical wall of the cylindro-conical subassembly, and within the annular gap 28 between the outer sleeve 26 and subassembly's cylindrical tank wall 12 prior to the step of filling the annular gap 28. The filling of the annular gap 28 with insulative foam occurs after any welding of the parts of the tank together—such as the continuous weld along seam 26a in the stainless steel outer sleeve 26, along seam 12a in stainless steel tank wall 12, and along seam 20a in support 20—so that all gaps may be filled with the foam. The composite structure of the steel sheet and rigid insulation together with the support cone 20 serves to replace the complicated leg structure normally required to support a conical fermenter so that only leveling foot pads are required. The binding of the elements together with the foam, and the use of the support 20, act to reduce the total energy used in producing and operating the fermenter because of the superior insulation and the reduced number of welded stainless parts used in fabrication. The rigid foam further provides insulation as well as bonding to the cones 14, 20 to become part of the support structure. Finally, the mated cones 14, 20 work together with the rigid foam to distribute the weight of the assembly 10 to the feet 25a-25d.

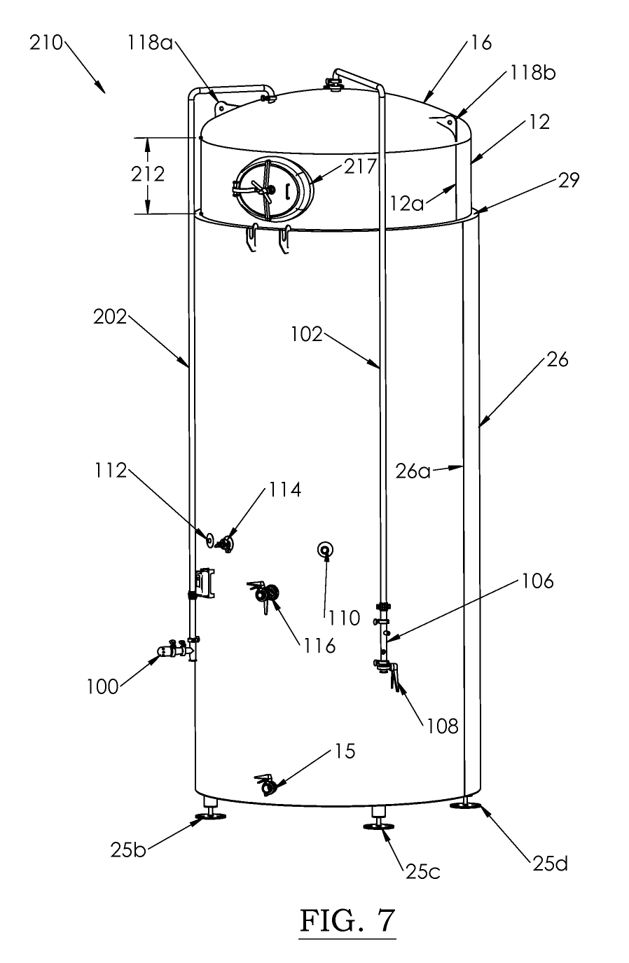

FIG. 7 illustrates an alternate embodiment of a fermentation tank assembly 210 as constructed according to teachings of the present invention Like numbers are associated with similar structures to those found in the previously-described fermentation tank 10 shown in FIGS. 1-6. Assembly 210 includes a tank subassembly with a cylindrical tank shell 12 and downwardly-directed frustoconical tank bottom 14 affixed to a bottom peripheral edge of the cylindrical tank shell 12. All welds will be continuous. Interior wetted welds are ground smooth so they are sanitary. The cone forming tank bottom 14 has a preferred angle A of 60° whereby the yeast and other solids which have fallen to the cone's apex can be simply flushed out of a drain port 15 at the apex. The tank subassembly is capped on a top end by a tank head 16 to form a stainless steel cylindro-conical vessel (CCV) having a sealed and pressurized interior chamber 18 in which the beer is stored and fermented. A cooling jacket 24 in then wrapped about the cylindrical tank shell 12 and infused with a coolant such as compressed glycol—circulated through jacket ports 24a and 24b—to help maintain the fluid within the fermentation tank at a desired temperature.

An outer cylindrical sleeve 26 is configured to receive a majority of the cylindrical tank shell 12, tank bottom 14, and support 20 to form the tank assembly 210, wherein the assembly includes an annular gap 28 between the tank shell 12 and outer sleeve 26, and a cavity 30 between the outer sleeve 26, tank bottom 14, and support 20. The cooling jacket 24 is installed around the cylindrical tank shell 12 within the annular gap 28. A support ring 29 bounds and seals a top of the annular gap 28 and is welded onto the outer sleeve 26 and sidewalls of the cylindrical tank shell 12, where the lower cavity is sealed in part by the extent of the support 20 lower peripheral edges 22 welded to the outer sleeve 26 of assembly 10 having the same diameter as the outside of support ring 29.

The fermentation tank assembly 210 includes a plurality of valves, ports, tubes, and other structures useful for the fermentation process and movement and maintenance of the tank assembly. As fermentation creates heat and pressure, a pressure and vacuum relief port 100 is coupled to tank head 16 via downtube 202 that runs down along an outside of the outer sleeve 26. A clean-in-place (CIP) downtube 102 is coupled to a central portion of tank head 16 and extends into the upper interior of the tank chamber 18, terminating in a rotating spray ball 104 for cleaning out the tank. Downtube 102 is coupled on an outside of the tank assembly 10 to a gas and pressure port 106 and to a butterfly valve 108. Fluid, either gas or fluid, is provided through ports 106, 108 to spray ball 104 which then sprays and cleans the interior 18 of the tank after each use. The cleaning fluid can then be exhausted from the chamber 18 out of the same drain port 15 as the solids and yeasts. Other ports into the interior of the tank are provided, including a carbonation port 110, a temperature well 112 through which a thermocouple is inserted to measure the temperature within the tank, and a sample port 114 through which the liquid stored and fermenting within the tank may be drawn and sampled. At least one racking arm, such as arm 116, is coupled to the tank to allow sampling of product from various levels within the tank by rotation of an angled tube. Lifting means are included such as lifting ears 118a, 118b formed on opposite sides of the tank head 16.

The outer cylindrical sleeve 26 is assembled about the cylindrical tank shell 12 in such a fashion such that an upper sidewall portion 212 is exposed, that is where the upper portion 212 of the cylindrical tank extends above a top edge of the outer cylindrical sleeve. A manway 217 is formed through this upper portion 212 of the cylindrical tank wall 12 between the outer cylindrical sleeve 26 and tank head 16. The manway forms a single penetration through the upper sidewall portion to an interior of the cylindro-conical container, which contrasts with conventional fermentation tanks where the manway is positioned lower on the tank wall and must breach two vessel walls—both the tank shell itself as well as the cylindrical sleeve. Fewer penetrations simplify the design, decrease manufacturing costs, and reduce the change for leak failures.

### The Fermentation Process

Fermentation is the process by which yeast converts the sugars in the wort to ethyl alcohol and carbon dioxide gas—giving the beer both its alcohol content and its carbonation. To begin the fermentation process, the cooled wort is transferred into fermentation vessel 10 along with the yeast. If the beer being made is an ale, the wort will be maintained at a constant temperature of 68° F. (20° C.) for about two weeks. If the beer is a lager, the temperature will be maintained at 48° F. (9° C.) for about six weeks. Since fermentation produces a substantial amount of heat, the tanks must be cooled constantly as by using cooling jacket 24 to maintain the proper temperature.

The fermentation process typically takes at least two weeks, so the capacity of the brewery is limited by how many tanks they have. When the wort is first added to the yeast, the specific gravity of the mixture drawn from the sample port 114 is measured. Later, the specific gravity may be measured again to determine how much alcohol is in the beer, and to know when to stop the fermentation.

The fermenter is sealed off from the air except for a long narrow vent pipe 102, which allows carbon dioxide to escape from the fermenter. Since there is a constant flow of CO₂ through the pipe, outside air is prevented from entering the fermenter, which reduces the threat of contamination by stray yeasts.

When fermentation is nearly complete, most of the yeast will settle to the bottom 14 of the fermenter. The bottom of the fermenter is cone shaped, which makes it easy to capture and remove the yeast, which is saved and used in the next batch of beer. The yeast can be reused a number of times before it needs to be replaced, e.g. when it has mutated and produces a different taste.

While fermentation is still happening, and when the specific gravity has reached a predetermined level, the carbon dioxide vent tube is capped. Now the vessel is sealed; so as fermentation continues, pressure builds as CO₂ continues to be produced. This is how the beer gets most of its carbonation, and the rest will be added manually later in the process. From this point on, the beer will remain under pressure (except for a short time during bottling).

When fermentation has finished, the beer is cooled to about 32° F. (0° C.). This helps the remaining yeast settle to the bottom of the fermenter, along with other undesirable proteins that come out of solution at this lower temperature.

Now that most of the solids have settled to the bottom, the beer is slowly pumped from the fermenter and filtered to remove any remaining solids. From the filter, the beer goes into another tank, called a bright beer tank. This is its last stop before bottling or kegging. Here, the level of carbon dioxide is adjusted by bubbling a little extra CO₂ into the beer through a porous stone.

Having described and illustrated the principles of the invention in a preferred embodiment thereof, it should be apparent that the invention can be modified in arrangement and detail without departing from such principles. We claim all modifications and variation coming within the spirit and scope of the invention.

What is claimed is:

1. A fermentation tank comprising:
a cylindrical tank shell;
a downwardly-directed frustoconical tank bottom affixed to a bottom edge of the cylindrical tank shell;
an upwardly-directed support positioned below the cylindrical tank shell having a centrally located aperture receiving a lower portion of the tank bottom;
an outer cylindrical sleeve configured to receive the cylindrical tank shell, tank bottom, and support to form a tank assembly, wherein the assembly includes an annular gap between the tank shell and sleeve, and a cavity between the sleeve, tank bottom, and support; and
rigid foam insulation filled within the annular gap and cavity.

2. The fermentation tank of claim 1, wherein the support includes an upwardly-directed frustoconical support positioned below the cylindrical tank shell having a centrally located aperture receiving a lower portion of the tank bottom.

3. The fermentation tank of claim 1, wherein the tank bottom forms a downward angle and the support forms an upward angle, where the downward angle is greater than the upward angle.

4. The fermentation tank of claim 1, further including a plurality of feet attached in spaced apart orientation to a lower peripheral edge of the frustoconical support.

5. The fermentation tank of claim 1, further including a cooling jacket installed around the cylindrical tank shell within the annular gap.

6. The fermentation tank of claim 1, further including a tank head affixed to a top edge of the cylindrical tank shell to form an enclosed and pressurized fermentation tank enclosure.

7. The fermentation tank of claim 6, further including a manway formed through the tank head and located above the outer cylindrical sleeve.

8. The fermentation tank of claim 1, wherein the frustoconical support includes at least one aperture therethrough in fluid communication with the cavity and with the annular gap, wherein the aperture is configured to receive the rigid foam insulation therethrough so that the foam can flow into and fill the cavity and annular gap.

9. The fermentation tank of claim 1, wherein the rigid foam is a polyurethane.

10. The fermentation tank of claim 6, wherein an upper portion of the cylindrical tank extends above the outer cylindrical sleeve, and wherein the fermentation tank further includes a manway formed through the upper portion of the cylindrical tank wall between the outer cylindrical sleeve and tank head.

11. A method for constructing a fermentation tank of a type having a cylindro-conical container, the method comprising:
supporting the cylindro-conical container in an upright orientation on an upwardly-directed frustoconical support to form an assembly;
assembling a cylindrical sleeve over the assembly so that an annular gap exists between the sleeve and assembly; and
filling the annular gap with a rigid foam.

12. The method of claim 11, wherein the step of filling the annular gap with rigid foam includes injecting foam through apertures formed through the frustoconical support, said apertures providing fluid communication between an underside of the support and the annular gap.

13. The method of claim 11, further including the step of supporting the assembly on a plurality of feet coupled in spaced-apart arrangement along a peripheral edge of the frustoconical support.

14. The method of claim 11, further including the step of installing a cooling jacket about a cylindrical wall of the cylindro-conical shape, and within the annular gap between the sleeve and assembly, prior to the step of filling the annular gap.

15. The method of claim 11 wherein the step of filling the annular gap with a rigid foam includes filling the annular gap with polyurethane.

16. The method of claim 11, further including the step of welding elements of the fermentation tank together and filling the annular gap with rigid foam after the welding step.

17. The method of claim 11, further including the step of forming a manway opening through a top portion of the cylindro-conical container and above the cylindrical sleeve.

18. The method of claim 17, further including the step of adding ingredients to the fermentation tank through the manway opening.

19. The method of claim 11, wherein the step of assembling the cylindrical sleeve includes positioning the sleeve in relation to the container such that an upper sidewall portion of the cylindro-conical container is exposed, the method further including forming a manway through the upper sidewall portion to an interior of the cylindro-conical container.

20. The method of claim 11, wherein the step of filing the annular gap with rigid foam includes applying the foam to an exterior of the cylindro-conical container prior to the step of assembling the cylindrical sleeve over the assembly.
